(19) United States
(12) Patent Application Publication
(10) Pub. No.: US 2026/0280201 A1
(43) Pub. Date: Sep. 17, 2026

(54) POWER CONNECTOR AND SIGNAL TRIGGER MECHANISM

(71) Applicant: OUPIIN ELECTRONIC (KUNSHAN) CO., LTD., Kunshan City (CN)

(72) Inventor: Hsin Chih CHEN, Kunshan City (CN)

(21) Appl. No.: 19/253,874

(22) Filed: Jun. 29, 2025

(30) Foreign Application Priority Data
Mar. 11, 2025 (CN) 202510282893.1
Mar. 11, 2025 (CN) 202520417068.3

(51) Int. Cl. H01R 13/707; H01R 13/10; H01R 13/50; H01R 13/713

(52) U.S. Cl. CPC H01R 13/707; H01R 13/10; H01R 13/50; H01R 13/713

(57) ABSTRACT

A power connector and a signal trigger mechanism are disclosed in this application. The power connector includes an insulation case, a power transmission assembly disposed in the insulation case, and at least one signal trigger mechanism disposed in the insulation case. The insulation case has a slot for inserting an insert. The signal trigger mechanism includes an active switch terminal and a passive switch terminal, which are independent of each other. The active switch terminal is used to make electrical contact with the insert only after the power transmission assembly is in electrical contact with the insert. The passive switch terminal is used to make electrical contact with the active switch terminal only after the active switch terminal is in electrical contact with the insert.

### CROSS REFERENCE TO RELATED APPLICATIONS

This application claims the benefit of priority of Chinese Patent Application Nos. 202510282893.1 and 202520417068.3, both filed Mar. 11, 2025, the contents of which are all incorporated herein by reference in their entirety.

### FIELD OF ART

The present application relates to a field of connector technology, and more specifically to a power connector and a signal trigger mechanism.

### BACKGROUND OF DISCLOSURE

The power connector is used to supply power to electrical equipment. For example, the power connector can be mounted to a server rack and connected to a busbar to supply power to the server rack.

At present, the power connector is required to enable hot-plugging with the busbar. However, this operation may generate electrical arcs that could lead to component breakdown or burnout. In order to reduce the generation of electrical arcs, detection terminals are installed in some power connectors, and the detection terminal is used to make electrical contact with the busbar to ensure that the busbar has been inserted into the power connector before supplying the power.

But it is still necessary to provide a safer and more reliable power connector to improve the safety of the electrical equipment.

### BRIEF SUMMARY OF DISCLOSURE

One object of the present application is to provide a power connector, which disposes an active switch terminal and a passive switch terminal to improve the safety of the power connector.

The other object of the present application is to provide a signal trigger mechanism having an active switch terminal and a passive switch terminal to stably and accurately trigger a power supply signal.

Other objects and advantages of the present application may be further understood from technical features disclosed by the present application.

To achieve the above objects of the present application, the present application adopts the following technical solution.

A power connector comprises an insulation case, a power transmission assembly being disposed in the insulation case, and at least one signal trigger mechanism being disposed in the insulation case. The insulation case has a slot for inserting an insert that can sequentially establish electrical contact with the power transmission assembly and the signal trigger mechanism. The signal trigger mechanism comprises an active switch terminal and a passive switch terminal, which are independent of each other. The active switch terminal has a switch fixing portion, an active contact portion, and an active trigger end arranged in sequence. The active contact portion protrudes into the slot and is used to establish electrical contact with the insert. Wherein, the active contact portion is brought into electrical contact with the insert only after the power transmission assembly is in electrical contact with the insert, and the active contact portion is forced by the insert to drive the active trigger end to move away from the slot. The passive switch terminal has a passive contact strip located on one vertical side of the active contact portion facing away from the slot. Wherein, the passive contact strip is brought into electrical contact with the active trigger end after the active contact portion is pressed by the insert to cause movement of the active trigger end, and the passive contact strip breaks electrical contact with the active trigger end after the insert withdraws from the slot and releases the active contact portion.

In one embodiment, the signal trigger mechanism and the power transmission assembly are arranged along a width direction of the slot; and the active switch terminal and the passive switch terminal are arranged along a thickness direction of the slot and define a switch gap.

In one embodiment, the switch fixing portion of the active switch terminal is connected to the power transmission assembly; and the passive switch terminal is independent of the power transmission assembly.

In one embodiment, the power transmission assembly includes a pair of power terminals and a pair of conductive plates. The pair of power terminals are distributed on two vertical sides of the slot for making electrical contact with two opposite insertion surfaces of the insert. The pair of conductive plates are respectively attached to outer surfaces of the pair of power terminals facing away from the slot; the switch fixing portion is connected one conductive plate of the pair of conductive plates. The active trigger end is closer to the passive contact strip than the active contact portion.

In one embodiment, the signal trigger mechanism is referred to as a first signal trigger mechanism; the power connector comprises another signal trigger mechanism, which is referred to as a second signal trigger mechanism; the second signal trigger mechanism has a same structure as the first signal trigger mechanism, and a different layout position from the first signal trigger mechanism; wherein, the first signal trigger mechanism is arranged on one lateral side of the one conductive plate, and the active switch terminal is connected the one conductive plate; and the second signal trigger mechanism is arranged on one lateral side of the other conductive plate of the pair of conductive plates away from the first signal trigger mechanism, and an active switch terminal of the second signal trigger mechanism is connected the other conductive plate.

In one embodiment, the insulation case disposes a pair of power transmission assembly-receiving grooves, which are respectively located on the two vertical sides of the slot for accommodating the power transmission assembly; the insulation case disposes a pair of signal trigger mechanism-receiving grooves, which are respectively located on the two vertical sides of the slot for accommodating the first signal trigger mechanism and the second signal trigger mechanism; each of the signal trigger mechanism-receiving grooves is arranged side by side with the corresponding power transmission assembly-receiving groove along a width direction of the slot; wherein, the power transmission assembly-receiving groove and the signal trigger mechanism-receiving groove located on one vertical side of the slot, and the power transmission assembly-receiving groove and the signal trigger mechanism-receiving groove located on the other vertical side of the slot, are arranged in parallel in a 180-degree horizontally flipped configuration; wherein, in each of the signal trigger mechanism-receiving grooves, the active switch terminal is disposed adjacent to the slot, while the passive switch terminal is arranged on one vertical side of the active switch terminal opposite to the slot.

In one embodiment, each of the signal trigger mechanism-receiving grooves is communicated with the corresponding power transmission assembly-receiving groove through a connection channel, and at least one part of the switch fixing portion of the active switch terminal passes through the connection channel.

In one embodiment, each of the power terminals is bent vertically twice to form a Z-shape, and has a power contact portion protruding into the slot, a power body portion and a power cable connection portion arranged in sequence; in the pair of power terminals, the power contact portions are used to commonly hold the insert, a gap between the power cable connection portions is less than a gap between the power body portions, and is less than or equal to a gap between the power contact portions.

In one embodiment, each of the conductive plates is bent vertically twice to form a Z-shape, and has a reinforcing portion, a conductive body portion, and a conductive fixing portion arranged in sequence; the conductive body portion is attached to the power body portion, the conductive fixing portion is attached to the power cable connection portion, and the reinforcing portion extends along the power contact portion; and the switch fixing portion of the active switch terminal is connected to the conductive body portion of the conductive plate.

In one embodiment, the active switch terminal and the conductive plate are configured as a one-piece structure or a two-piece structure; the switch fixing portion of the active switch terminal is an L-shaped flat plate; one end of the switch fixing portion is connected to the conductive body portion, and the other end of the switch fixing portion is connected to the active contact portion; the active contact portion is located on one lateral side of the power contact portion and behind the power contact portion.

In one embodiment, the switch fixing portion, the active contact portion and the active trigger end of the active switch terminal are located on one vertical side of the passive switch terminal facing the slot; and the passive contact strip of the passive switch terminal is flat, and a free end of the passive contact strip and the active trigger end are facing in a same direction.

In one embodiment, the active contact portion and the active trigger end are located on one vertical side of the passive switch terminal facing the slot, and the switch fixing portion is located on the other vertical side of the passive switch terminal facing away from the slot; the switch fixing portion is bent 180 degrees around a front end of the passive contact strip and connected to the active contact portion; the active trigger end is a free end of the active contact portion; a free end of the passive contact strip and the active trigger end are facing in opposite directions.

In one embodiment, the power transmission assembly at least includes a pair of power terminals, which are distributed on two vertical sides of the slot for making electrical contact with two opposite insertion surfaces of the insert; the switch fixing portion of the active switch terminal is connected to one power terminal; the active trigger end of the active switch terminal is closer to the passive contact strip of the passive switch terminal than the active contact portion.

In one embodiment, each of the power terminals has a power contact portion protruding into the slot, a power body portion and a power cable connection portion arranged in sequence; the switch fixing portion of the active switch terminal is connected to the power body portion of the corresponding power terminal.

In one embodiment, the active switch terminal and the passive switch terminal are independent of the power transmission assembly; the active switch terminal is directly fixed in the insulation case through the switch fixing portion; the active switch terminal and the passive switch terminal are arranged along a thickness direction of the slot and define a switch gap.

To achieve the above objects of the present application, the present application also adopts the following technical solution.

A signal trigger mechanism is used to establish electrical contact with an insert and trigger a signal, and comprises an active switch terminal and a passive switch terminal. The active switch terminal has a switch fixing portion, an active contact portion and an active trigger end arranged in sequence. Wherein, the active contact portion is used to establish electrical contact with the insert, and the active trigger end is forced to move after the active contact portion is in electrical contact with the insert. The passive switch terminal is independent of the active switch terminal. The active switch terminal and the passive switch terminal define a switch gap. The passive switch terminal has a passive contact strip and a signal cable connection portion. The signal cable connection portion is connected to at least one signal cable, and the passive contact strip is located on a movement path of the active trigger end. Wherein, the passive contact strip is brought into electrical contact with the active trigger end after the active contact portion is in electrical contact with the insert, and the passive contact strip breaks electrical contact with the active trigger end after the insert releases the active contact portion.

In one embodiment, the switch gap is a distance between the active trigger end and the passive contact strip; and the passive contact strip is flat, and a free end of the passive contact strip and the active trigger end are facing in a same direction or in opposite directions.

In comparison with the prior art, the signal trigger mechanism of the present application disposes the active switch terminal and the passive switch terminal, and the passive switch terminal is set on a movement path of the active switch terminal pressed by the insert, so the active switch terminal can touch the passive switch terminal and establish electrical connection therebetween to stably and accurately trigger the power supply signal after the active switch terminal is pressed down by the insert. By adopting the signal trigger mechanism, the power connector of the present application enables the insert to sequentially establish electrical contact with the power transmission assembly and the signal trigger mechanism. Therefore, the power transmission assembly has already made electrical contact with the insert before power supply, thus avoiding arc generation. Moreover, due to the independent arrangement of the active switch terminal and the passive switch terminal, if the insert is frequently inserted into the slot, the active switch terminal will be frequently pressed, but the active switch terminal will not affect the structural stability of the passive switch terminal. For example, the active switch terminal will not cause the passive switch terminal to loosen in the signal trigger mechanism-receiving groove, and will not cause the connection between the signal cable connection portion and the signal cable to loosen. When the active switch terminal is pressed by the insert and its active trigger end moves toward the passive switch terminal, the passive switch terminal can provide a support or lifting effect to the active trigger end to avoid excessive deformation of the active switch terminal. Hence, the power supply signal of the power connector of the present application can be stably and accurately triggered and the power connector has good safety.

### BRIEF DESCRIPTION OF DRAWINGS

FIG. 1 is a perspective schematic view of a first embodiment of a power connector of the present application;

FIG. 2 is a side view of the power connector shown in FIG. 1;

FIG. 3 is a rear view of the power connector shown in FIG. 1;

FIG. 4 is a rear view of an insulation case of the power connector shown in FIG. 1;

FIG. 5 is an exploded view of the power connector shown in FIG. 1;

FIG. 6 is an exploded view of the power connector shown in FIG. 1 from another angle;

FIG. 7 is a perspective schematic view of a power transmission assembly and two signal trigger mechanisms in the first embodiment;

FIG. 8 is a side view of the power transmission assembly and the two signal trigger mechanisms shown in FIG. 7;

FIG. 9 is an exploded view of the power transmission assembly and the two signal trigger mechanisms shown in FIG. 7;

FIG. 10 is a further exploded view of a portion of the power transmission assembly and a first signal trigger mechanism shown in FIG. 9;

FIG. 11 is another embodiment of the first signal trigger mechanism of the present application;

FIG. 12 is an exploded view of a second embodiment of the power connector of the present application;

FIG. 13 is a perspective schematic view of the power transmission assembly and the two signal trigger mechanisms in the second embodiment;

FIG. 14 is an exploded view of the power transmission assembly and the two signal trigger mechanisms shown in FIG. 13;

FIG. 15 is a further exploded view of a portion of the power transmission assembly and the first signal trigger mechanism shown in FIG. 14;

FIG. 16 is an exploded view of a third embodiment of the power connector of the present application;

FIG. 17 is an exploded view of the power transmission assembly and the two signal trigger mechanisms shown in FIG. 16; and

FIG. 18 is a further exploded view of a portion of the power transmission assembly and the first signal trigger mechanism shown in FIG. 16.

### DETAILED DESCRIPTION OF PREFERRED EMBODIMENTS

The following description of every embodiment with reference to the accompanying drawings is used to exemplify a specific embodiment, which may be carried out in the present application. Directional terms mentioned in the present application, such as “top”, “bottom”, “front”, “back”, “left”, “right”, “upper”, “lower” etc., are only used with reference to the orientation of the accompanying drawings. Therefore, the used directional terms are intended to illustrate, but not to limit, the present application.

A power connector of the present application can be installed on a server rack. When an insert, such as a busbar, is inserted into the power connector, power can be supplied to the server rack.

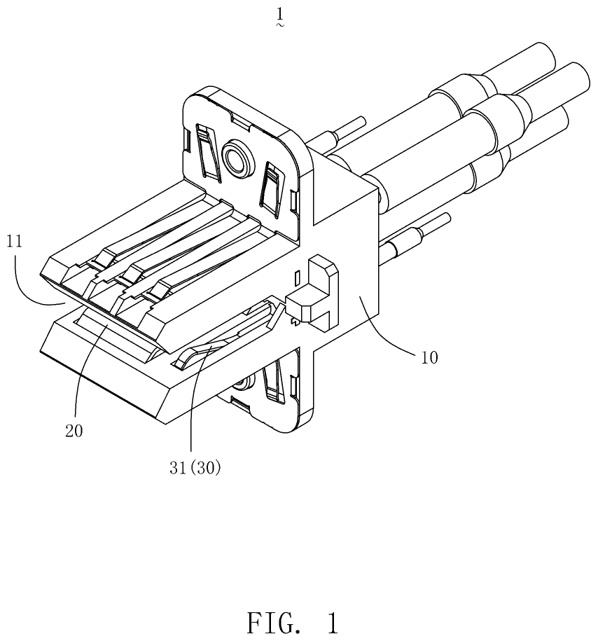

Please refer to FIGS. 1 to 10, in a first embodiment, the power connector 1 includes an insulation case 10, a power transmission assembly 20 disposed in the insulation case 10, and at least one signal trigger mechanism 30 disposed in the insulation case 10.

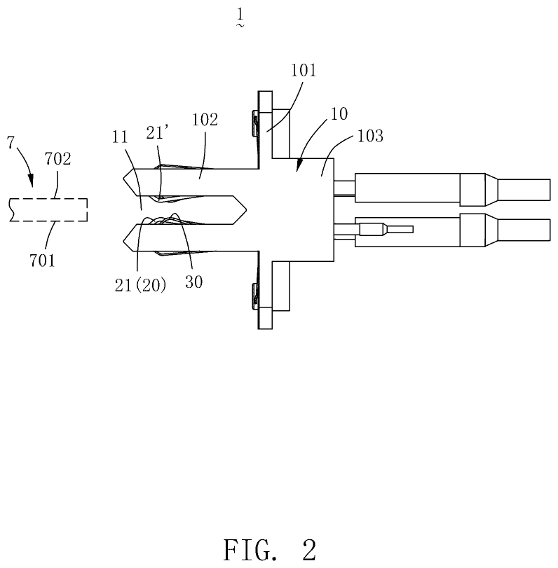

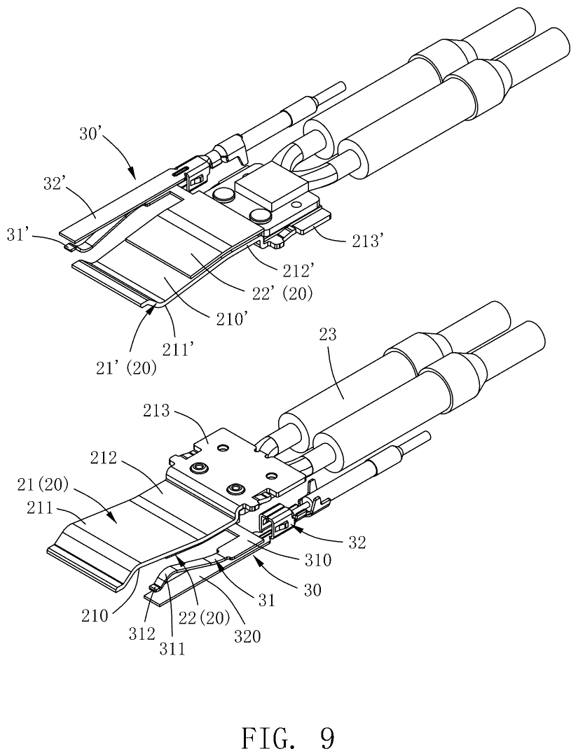

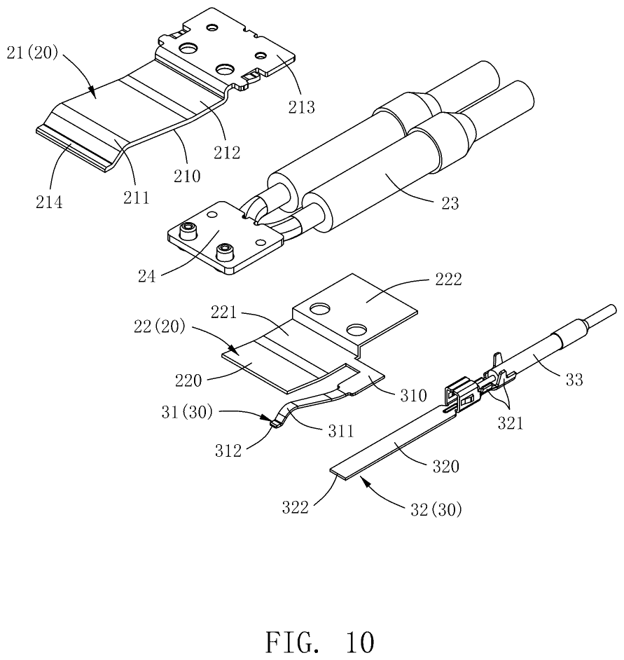

Please refer to FIGS. 1 and 2, the insulation case 10 has a slot 11 for inserting an insert 7, and the insert 7 can sequentially establish electrical contact with the power transmission assembly 20 and the signal trigger mechanism 30. The insert 7 may be a busbar. Please refer to FIGS. 9 and 10, the signal trigger mechanism 30 includes an active switch terminal 31 and a passive switch terminal 32 being independent of the active switch terminal 31. The active switch terminal 31 has a switch fixing portion 310, an active contact portion 311, and an active trigger end 312 arranged in sequence. The active contact portion 311 protrudes into the slot 11 and is used to establish electrical contact with the insert 7. The active contact portion 311 is brought into electrical contact with the insert 7 only after the power transmission assembly 20 is in electrical contact with the insert 7, and the active contact portion 311 is forced by the insert 7 to drive the active trigger end 312 to move away from the slot 11. The passive switch terminal 32 has a passive contact strip 320 located on one vertical side (e.g. a lower side) of the active contact portion 311 facing away from the slot 11. The passive contact strip 320 is brought into electrical contact with the active trigger end 312 after the active contact portion 311 is pressed by the insert 7 to cause movement of the active trigger end 312, and the passive contact strip 320 breaks electrical contact with the active trigger end 312 after the insert 7 withdraws from the slot 11 and releases the active contact portion 311.

Through the above settings, when the active switch terminal 31 touches the passive switch terminal 32, a power supply system of the power connector 1 will receives a power supply signal, and then the power supply system will supply power to the insert 7. Since the power transmission assembly 20 has already made electrical contact with the insert 7 before power supply, no arc will be generated between the power transmission assembly 20 and the insert 7 during power supply.

It should be noted that the “a passive switch terminal 32 being independent of the active switch terminal 31” mentioned in the embodiment refers that: the active switch terminal 31 and the passive switch terminal 32 do not establish connection or contact before the insert 7 is inserted into the slot 11.

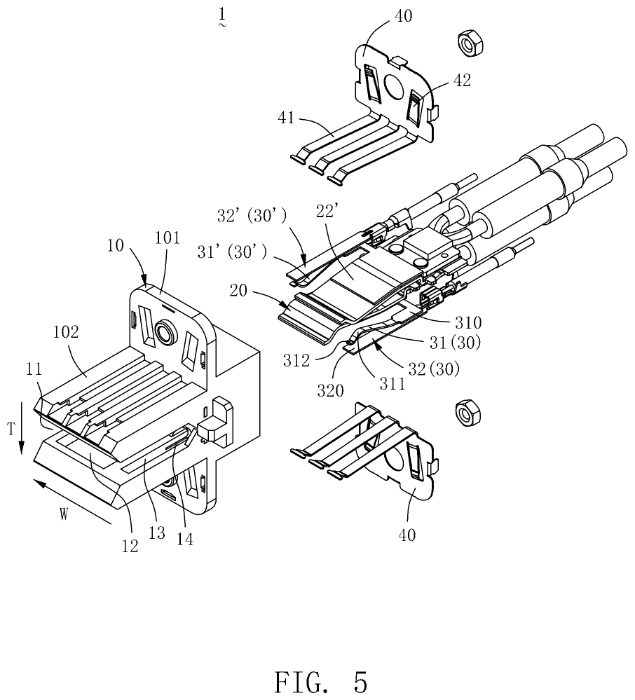

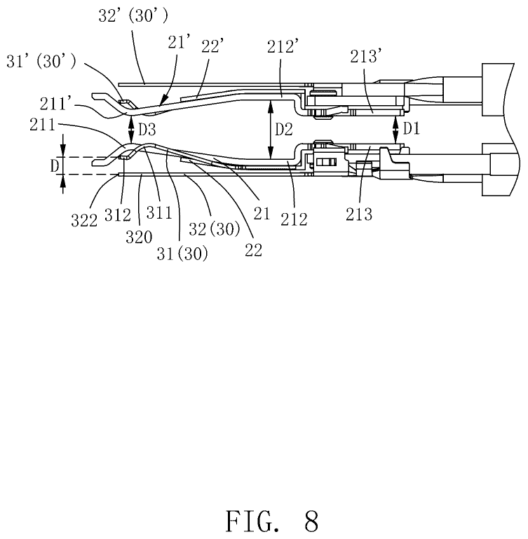

In the first embodiment, referring to FIGS. 1 and 5, the signal trigger mechanism 30 and the power transmission assembly 20 are arranged along a width direction W of the slot 11; and the active switch terminal 31 and the passive switch terminal 32 are arranged along a thickness direction T of the slot 11 and define a switch gap D (seen in FIG. 8). In the embodiment, the switch gap D refers to a distance between the active trigger end 312 and the passive contact strip 320. Moreover, in the embodiment, the active switch terminal 31 is located as a whole on one vertical side (e.g. an upper side) of the passive switch terminal 32 facing the slot 11.

In the first embodiment, the active switch terminal 31 is connected to the power transmission assembly 20. Further, the active switch terminal 31 is connected to the power transmission assembly 20 by the switch fixing portion 310. Thus, the active switch terminal 31 is fixed in the insulation case 10 by the power transmission assembly 20. The passive switch terminal 32 is independent of the power transmission assembly 20.

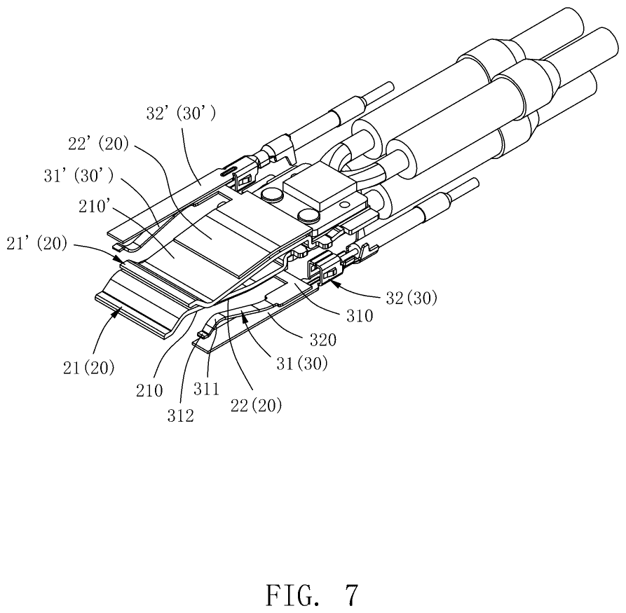

Specifically, please refer to FIGS. 7, 9 and 10, the power transmission assembly 20 includes a pair of power terminals and a pair of conductive plates. The pair of power terminals includes a first power terminal 21 and a second power terminal 21′, which are distributed on two vertical sides (including a lower side and an upper side) of the slot 11 for making electrical contact with two opposite insertion surfaces 701, 702 of the insert 7. The pair of conductive plates includes a first conductive plate 22 and a second conductive plate 22′, which are respectively attached to outer surfaces of the pair of power terminals facing away from the slot 11. For example, the first conductive plate 22 is attached to the outer surface 210 of the first power terminal 21 facing away from the slot 11, and the second conductive plate 22′ is attached to the outer surface 210′ of the second power terminal 21′ facing away from the slot 11. The switch fixing portion 310 of the active switch terminal 31 is connected to one of the conductive plates (e.g. the first conductive plate 22). The active trigger end 312 of the active switch terminal 31 is closer to the passive contact strip 320 of the passive switch terminal 32 than the active contact portion 311. The passive switch terminal 32 is independent of the active switch terminal 31, the first power terminal 21, and the first conductive plate 22. That is, the passive switch terminal 32 is independent of the active switch terminal 31, the first power terminal 21, and the first conductive plate 22 before the insertion of the insert 7.

In the first embodiment, the power connector 1 further includes another signal trigger mechanism 30′, as shown in FIGS. 5 to 9. The another signal trigger mechanism 30′ includes an active switch terminal 31′ and a passive switch terminal 32′, which are independent of each other.

The signal trigger mechanism 30 is referred to as a first signal trigger mechanism. The active switch terminal 31 is referred to as a first active switch terminal. The passive switch terminal 32 is referred to as a first passive switch terminal. The another signal trigger mechanism 30′ is referred to as a second signal trigger mechanism. The active switch terminal 31′ is referred to as a second active switch terminal. The passive switch terminal 32′ is referred to as a second passive switch terminal.

The second signal trigger mechanism has a same structure as the first signal trigger mechanism, and a different layout position from the first signal trigger mechanism. For example, the first signal trigger mechanism is arranged on one lateral side (e.g. a right side in FIG. 9) of one of the conductive plates (e.g. the first conductive plate 22), and the active switch terminal 31 (i.e. the first active switch terminal) is connected to one of the conductive plates; the second signal trigger mechanism is arranged on one lateral side (e.g. a left side in FIG. 9) of the other of the conductive plates (e.g. the second conductive plate 22′) away from the first signal trigger mechanism, and the active switch terminal 31′ (i.e. the second active switch terminal) is connected to the other of the conductive plates. That is to say, as shown in FIG. 9, the first signal trigger mechanism is located on the right side of one of the conductive plates (i.e. the first conductive plate 22), while the second signal trigger mechanism is located on the left side of the other of the conductive plates (i.e. the second conductive plate 22′).

Structural details of the power connector 1 according to the first embodiment of the present application will be specifically explained below.

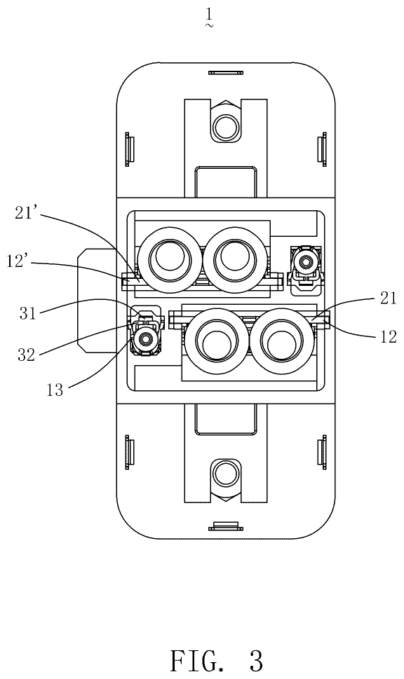

Please refer to FIGS. 3 to 6, in addition to the slot 11, the insulation case 10 is further provided with a pair of power transmission assembly-receiving grooves (including a lower power transmission assembly-receiving groove 12 and an upper power transmission assembly-receiving groove 12′), which are respectively disposed on the two vertical sides of the slot 11 for accommodating the power transmission assembly 20. The pair of conductive plates (i.e. the first conductive plate 22 and the second conductive plate 22′) and the pair of power terminals (i.e. the first power terminal 21 and the second power terminal 21′) are received in the pair of power transmission assembly-receiving grooves.

Please refer to FIGS. 3 to 6, the insulation case 10 is further provided with at least one signal trigger mechanism-receiving groove, which is referred to as a first signal trigger mechanism-receiving groove 13, and is disposed on a lateral side (i.e. a right side of FIG. 5) of one of the power transmission assembly-receiving grooves (i.e. the lower power transmission assembly-receiving groove 12 shown in FIG. 5) for receiving the signal trigger mechanism 30 (i.e. the first signal trigger mechanism). Wherein, the active switch terminal 31 is disposed adjacent to the slot 11, while the passive switch terminal 32 is disposed far away from the slot 11. That is to say, in the signal trigger mechanism-receiving groove (i.e. the first signal trigger mechanism-receiving groove 13) located on the lower side of the slot 11, the active switch terminal 31 is arranged on the upper side of the passive switch terminal 32.

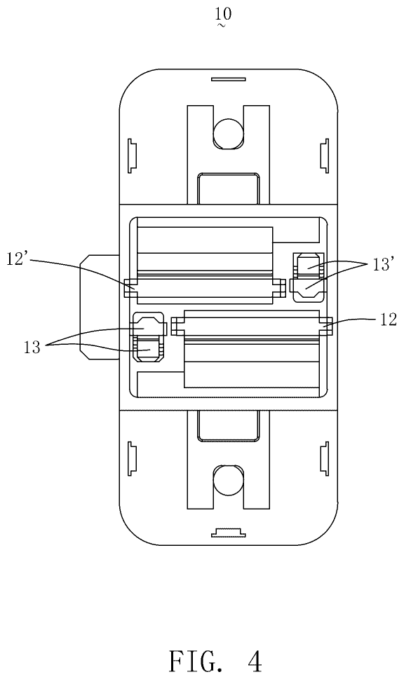

More specifically, as shown in FIGS. 4 and 5, the insulation case 10 includes a pair of signal trigger mechanism-receiving grooves (including the first signal trigger mechanism-receiving groove 13 and a second signal trigger mechanism-receiving groove 13′), which are respectively located on the two vertical sides of the slot 11, and each of which is arranged side by side with the corresponding power transmission assembly-receiving groove along the width direction W of the slot 11. For example, in a rear view of the insulation case 10 shown in FIG. 4, the first signal trigger mechanism-receiving groove 13 is located on the left side of the lower power transmission assembly-receiving groove 12 to be used for receiving the first signal trigger mechanism (such as the signal trigger mechanism 30); the second signal trigger mechanism-receiving groove 13′ is located on the right side of the upper power transmission assembly-receiving groove 12′ to be used for receiving the second signal trigger mechanism (such as the another signal trigger mechanism 30′). Furthermore, the insulation case 10 is also provided with a connection channel 14 (seen in FIG. 5) to connect the one signal trigger mechanism-receiving groove (i.e. the first signal trigger mechanism-receiving groove 13) and the corresponding power transmission assembly-receiving groove (i.e. the lower power transmission assembly-receiving groove 12). Specifically, the connection channel 14 is used to allow at least one part of the switch fixing portion 310 of the active switch terminal 31 to pass through, and the active trigger end 312 and the active contact portion 311 enter into the one signal trigger mechanism-receiving grooves. In the one signal trigger mechanism-receiving groove, the active contact portion 311 protrudes into the slot 11 and out of the one signal trigger mechanism-receiving groove, but the active trigger end 312 is remained in the one signal trigger mechanism-receiving groove to be ready to move and make electrical contact with the passive switch terminal 32 after the active contact portion 311 is pressed down or pushed up by the insert 7.

Referring to FIG. 4, the lower power transmission assembly-receiving groove 12 and the first signal trigger mechanism-receiving groove 13 located on the lower side of the slot 11, and the upper power transmission assembly-receiving groove 12′ and the second signal trigger mechanism-receiving groove 13′ located on the upper side of the slot 11, are arranged in parallel in a 180-degree horizontally flipped configuration along a left-right direction of FIG. 4.

Moreover, referring to FIG. 2, the insulation case 10 also includes a flange 101, a front insulation portion 102 located in front of the flange 101, and a rear insulation portion 103 located behind the flange 101. The slot 11 is disposed in the front insulation portion 102. The power transmission assembly-receiving groove (i.e. the lower power transmission assembly-receiving groove 12) and the signal trigger mechanism-receiving groove (i.e. the first signal trigger mechanism-receiving groove 13) extend in the front insulation portion 102 and pass through the rear insulation portion 103. Referring to FIG. 5, the power connector 1 includes a pair of grounding terminals 40 mounted on the flange 101. Each grounding terminal 40 is provided with multiple of first spring fingers 41 extending along the front insulation portion 102, and multiple of second spring fingers 42 extending along the flange 101 and being perpendicular to the first spring fingers 41.

Please referring to FIGS. 9 and 10, each of the power terminals, such as the first power terminal 21, is roughly Z-shaped after two vertical bends and has a power contact portion 211 protruding into the slot 11, a power body portion 212 and a power cable connection portion 213 arranged in sequence. More specifically, the power contact portion 211 is bent into a rough V-shape, protruding into the slot 11 to form electrical contact with the insert 7. The power cable connection portion 213 is a flat plate and is used to be fixedly connected with at least one power cable 23. In the embodiment, the power cable connection portion 213 is fixedly connected with the power cable 23 through the first conductive plate 22. Furthermore, the power cable connection portion 213 is fixedly connected with the power cable 23 through the first conductive plate 22 and a welding plate 24.

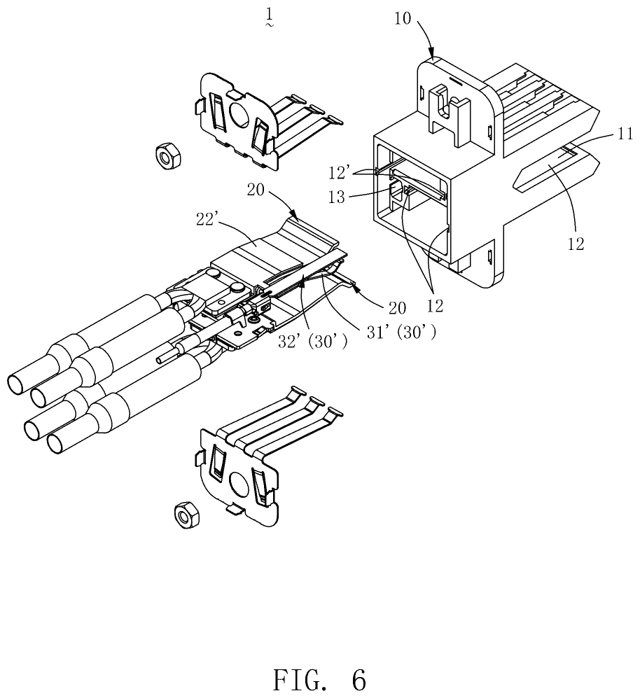

In this embodiment, as shown in FIGS. 2, 8 and 9, the pair of power terminals are received in the corresponding power transmission assembly-receiving grooves (i.e. the lower power transmission assembly-receiving groove 12 and the upper power transmission assembly-receiving groove 12′), wherein the labels 12 and 12′ are seen in FIG. 6. In the pair of power terminals, the power contact portion 211 of the first power terminal 21 and the power contact portion 211′ of the second power terminal 21′ are used to commonly hold the insert 7, the power body portion 212 of the first power terminal 21 and the power body portion 212′ of the second power terminal 21′ are far away from each other, and after two vertical bends, the power cable connection portion 213 of the first power terminal 21 and the power cable connection portion 213′ of the second power terminal 21′ are brought closer to each other. Therefore, generally, a gap D1 between the power cable connection portions 213, 213′ is less than a gap D2 between the power body portions 212, 212′, and is less than or equal to a gap D3 between the power contact portions 211, 211′.

Moreover, as shown in FIG. 10, each of the power terminals, such as the first power terminal 21, also has a power head 214 located at a front end of the power contact portion 211 and can be embedded in a front end of the power transmission assembly-receiving groove (i.e. the lower power transmission assembly-receiving groove 12) to prevent it from lifting.

Please refer to FIGS. 9 and 10, the pair of conductive plates are respectively attached to the corresponding outer surfaces of the pair of power terminals facing away from the slot 11. Each conductive plate is accommodated together with the corresponding power terminal in the corresponding power transmission assembly-receiving groove. Specifically, please refer to FIG. 10, each conductive plate, such as the first conductive plate 22, is roughly Z-shaped after two vertical bends and has a reinforcing portion 220, a conductive body portion 221, and a conductive fixing portion 222 arranged in sequence. The conductive body portion 221 is attached to the power body portion 212. The conductive fixing portion 222 is a flat plate and is attached to the power cable connection portion 213. The reinforcing portion 220 is slightly bent or slightly inclined relative to the conductive body portion 221, and extends along the power contact portion 211 of the first power terminal 21, thereby enhancing the strength of the power contact portion 211. The length of the reinforcing portion 220 can be determined according to the materials of the first power terminal 21 and the first conductive plate 22, or can be determined according to the required mechanical or electrical properties. In summary, the first conductive plate 22 is in contact with at least one portion of the first power terminal 21, thereby improving the reliability of electrical contact and the safety of mechanical connection between the first power terminal 21 and the insert 7.

In the first embodiment, as shown in FIGS. 9 and 10, the active switch terminal 31 is connected to the first conductive plate 22 and is arranged in parallel with the first conductive plate 22. Specifically, the switch fixing portion 310 is connected to the conductive body portion 221. For example, the active switch terminal 31 and the first conductive plate 22 are configured as a one-piece or integrated structure by a stamping process, and the switch fixing portion 310 is formed on and extends from a lateral side edge of the conductive body portion 221. Of course, the active switch terminal 31 and the first conductive plate 22 can be separately manufactured into a two-piece or split structure, and the switch fixing portion 310 can be connected to the conductive body portion 221 through welding or other methods.

Referring to FIG. 10, the switch fixing portion 310 is an L-shaped flat plate. One end of the switch fixing portion 310 is connected to the conductive body portion 221, and the other end of the switch fixing portion 310 is connected to the active contact portion 311. The active contact portion 311 is bent into a rough V-shape, and protrudes into the slot 11 to be used to form electrical contact with the insert 7. When the first conductive plate 22 is attached to the outer surface of the first power terminal 21, as shown in FIG. 9, the active contact portion 311 is located on a lateral side (i.e. a right side or a left side) of the power contact portion 211, the active contact portion 311 and the power contact portion 211 have approximately the same height, and the active contact portion 311 and the power contact portion 211 are arranged in a staggered manner along a front-back direction. For example, the active contact portion 311 is located in rear of the power contact portion 211. Through this design, the active contact portion 311 can make electrical contact with the insert 7 only after the first power terminal 21 has made electrical contact with the insert 7. In the embodiment, the active trigger end 312 is a free end (i.e. a front end) of the active contact portion 311. The active trigger end 312 extends toward a front end of the first signal trigger mechanism-receiving groove 13 and is embedded in the first signal trigger mechanism-receiving groove 13. This not only prevents the active switch terminal 31 from lifting, but also allows the active contact portion 311 to move toward the passive switch terminal 32 when the active contact portion 311 is pressed by the insert 7, thereby realizing reliable electrical contact between the active contact portion 311 and the passive switch terminal 32.

Referring to FIG. 8, the active switch terminal 31 and the passive switch terminal 32 are arranged along the thickness direction T of the slot 11 and define the switch gap D, and the active switch terminal 31 is located on one vertical side of the passive switch terminal 32 facing the slot 11. It can be seen that the passive switch terminal 32 is set on a movement path of the active switch terminal 31 pressed by the insert 7. Specifically, the passive switch terminal 32 is independent of the active switch terminal 31, the first power terminal 21 and the first conductive plate 22. The passive switch terminal 32 and the active switch terminal 31 are commonly accommodated in the first signal trigger mechanism-receiving groove 13 and are roughly arranged in an up-down configuration. For example, for the first signal trigger mechanism, the passive switch terminal 32 is located below the active switch terminal 31. For the second signal trigger mechanism, the passive switch terminal 32′ is located above the active switch terminal 31′.

In the embodiment, the active trigger end 312 is closer to the passive contact strip 320 of the passive switch terminal 32 than the active contact portion 311, and the active trigger end 312 extends toward the front end of the first signal trigger mechanism-receiving groove 13.

More specifically, in the first embodiment, as shown in FIGS. 8 and 10, the passive contact strip 320 is flat, and a free end 322 of the passive contact strip 320 and the active trigger end 312 both face in a same direction, for example, both face the front end of the first signal trigger mechanism-receiving groove 13. The free end 322 of the passive contact strip 320 is roughly aligned with the corresponding active trigger end 312, and may also exceed the active trigger end 312. That is to say, the length of the passive contact strip 320 can ensure that the active trigger end 312 and the passive contact strip 320 can establish electrical contact therebetween after the insertion of the insert 7, and even the length of the passive contact strip 320 can allow the active trigger end 312 to slide on the passive contact strip 320. Moreover, as shown in FIG. 10, the passive switch terminal 32 further includes a signal cable connection portion 321, which is horizontally and linearly connected to the passive contact strip 320 and is fixedly connected to at least one signal cable 33.

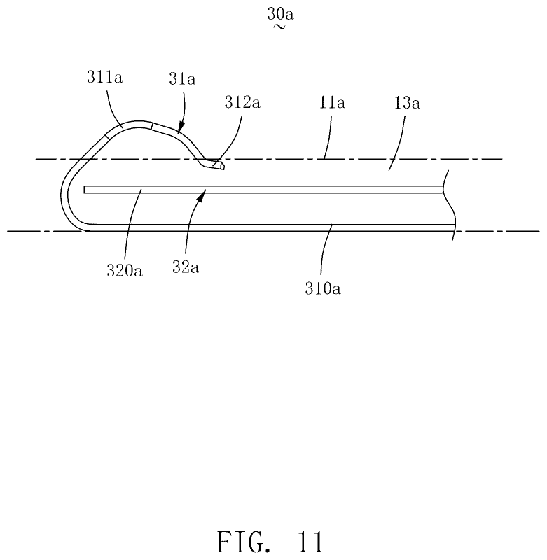

However, the present application does not limit vertical positions of the passive switch terminal 32 and the active switch terminal 31. As long as the passive contact strip 320 of the passive switch terminal 32 is set on the movement path of the active trigger terminal 312 of the active switch terminal 31, the electrical contact between the passive switch terminal 32 and the active switch terminal 31 can be achieved. For example, please refer to FIG. 11, which shows another embodiment of the present application, the another embodiment provides a signal trigger mechanism 30a, referred to as the first signal trigger mechanism.

Like elements or structures of the embodiment of FIG. 11 with the first embodiment of FIGS. 1 to 10 share the same reference numerals with the addition of the suffix “a”.

In the embodiment shown by FIG. 11, an active switch terminal 31a partially surrounds a passive switch terminal 32a. A portion of the active switch terminal 31a (such as an active contact portion 311a and an active trigger terminal 312a) may be located on one vertical side of the passive switch terminal 32a facing a slot 11a, while another portion of the active switch terminal 31a (such as a switch fixing portion 310a) may be located on the other vertical side of the passive switch terminal 32a away from the slot 11a. That is, a passive contact strip 320a of the passive switch terminal 32a is closer to the slot 11a than the switch fixing portion 310a of the active switch terminal 31a.

Specifically, in the embodiment shown by FIG. 11, for the first signal trigger mechanism, the passive contact strip 320a is located above the switch fixing portion 310a, the switch fixing portion 310a is bent approximately 180 degrees around a front end of the passive contact strip 320a and connected to the active contact portion 311a, and the active trigger end 312a is a free end (i.e. a rear end) of the active contact portion 311a and extends toward a rear end of a first signal trigger mechanism-receiving groove 13a. At this time, the active contact portion 311a is located above the passive contact strip 320a and protrudes into the slots 11a, the active trigger end 312a is also located above the passive contact strip 320a, and the active trigger end 312a and a free end 322a of the passive contact strip 320a are facing in opposite directions. These configuration can ensure a safe contact between the active switch terminal 31a and the insert 7 (seen in FIG. 2).

Similarly, a second signal trigger mechanism of the present application (i.e., another signal trigger mechanism 30′) can also adopt structures shown in FIG. 11. This will not be further described here.

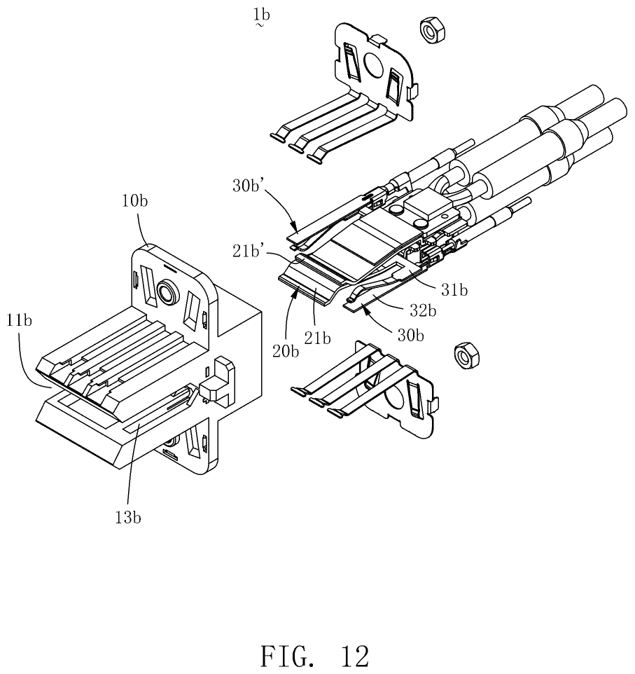

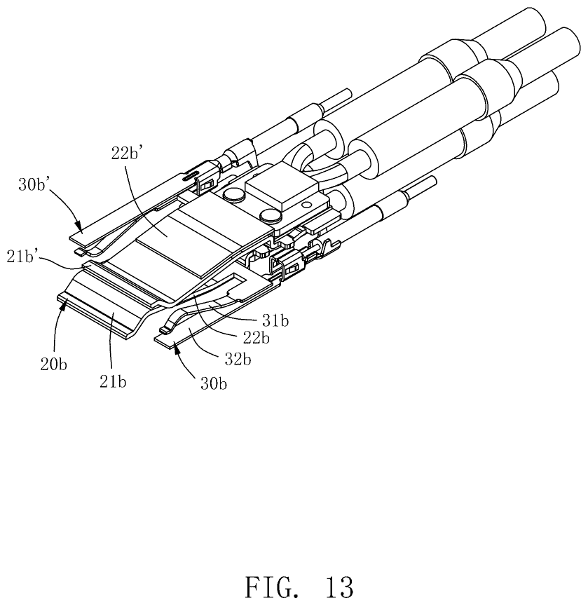

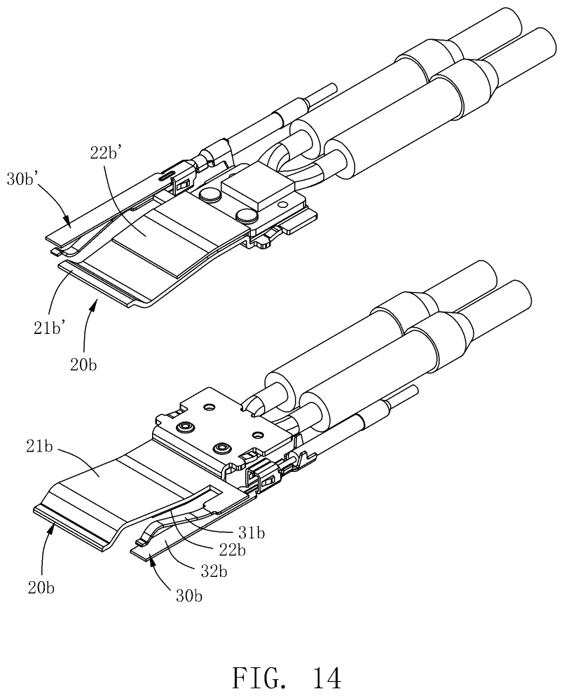

Please refer to FIGS. 12 to 15, which show a second embodiment of the present application, the second embodiment provides a power connector 1b. Like elements or structures of the second embodiment with the first embodiment of FIGS. 1 to 10 share the same reference numerals with the addition of the suffix “b”.

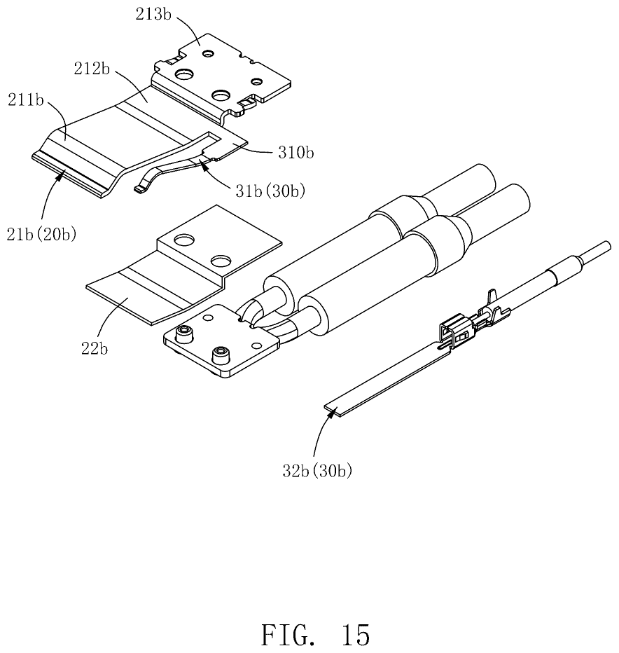

The structure of the power connector 1b of the second embodiment is roughly the same as that of the power connector 1 of the first embodiment. For example, in the second embodiment, as shown in FIGS. 12 to 15, the power connector 1b includes an insulation case 10b, a power transmission assembly 20b disposed in the insulation case 10b, and at least one signal trigger mechanism 30b disposed in the insulation case 10b. The signal trigger mechanism 30b includes an active switch terminal 31b and a passive switch terminal 32b, which are independent of each other. The power transmission assembly 20b at least includes a pair of power terminals, which includes a first power terminal 21b and a second power terminal 21b′. In the second embodiment, as shown in FIG. 15, each of the power terminals, such as the first power terminal 21b, has a power contact portion 211b protruding into a slot 11b, a power body portion 212b and a power cable connection portion 213b arranged in sequence.

The other similar structures between the second embodiment and the first embodiment mentioned will not be elaborated here.

The main difference between the power connector 1b of the second embodiment and the power connector 1 of the first embodiment is that: in the second embodiment, a switch fixing portion 310b of the active switch terminal 31b is connected to one power terminal (such as the first power terminal 21b) of the power transmission assembly 20b. Specifically, the switch fixing portion 310b is connected to the power body portion 212b. By connecting the active switch terminal 31b to the first power terminal 21b, the active switch terminal 31b can be positioned in one signal trigger mechanism-receiving groove (such as a first signal trigger mechanism-receiving groove 13b), thereby achieving the fixation of the active switch terminal 31b.

In the second embodiment, the active switch terminal 31b and the first power terminal 21b are configured as a one-piece or integrated structure by a stamping process. Of course, the active switch terminal 31b and the first power terminal 21b also can be separately manufactured into a two-piece or split structure, and the switch fixing portion 310b can be connected to the power body portion 212b through welding or other methods.

Moreover, in the second embodiment, a conductive plate is not a necessary component. Of course, based on an actual structural strength of the power connector 1b, the power connector 1b may be provided with a pair of conductive plates (including a first conductive plate 22b and a second conductive plate 22b′) to provide structural reinforcement for the pair of power terminals.

It should be noted that the power connector 1b also includes another signal trigger mechanism 30b′. If the above signal trigger mechanism 30b is referred to as a first signal trigger mechanism, then the another signal trigger mechanism 30b′ is referred to as a second signal trigger mechanism. The first signal trigger mechanism and the second signal trigger mechanism can also adopt the structure shown in FIG. 11.

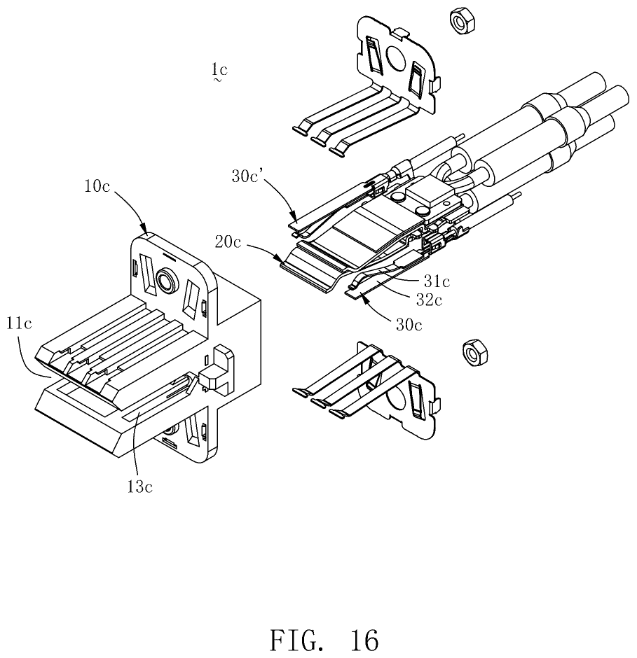

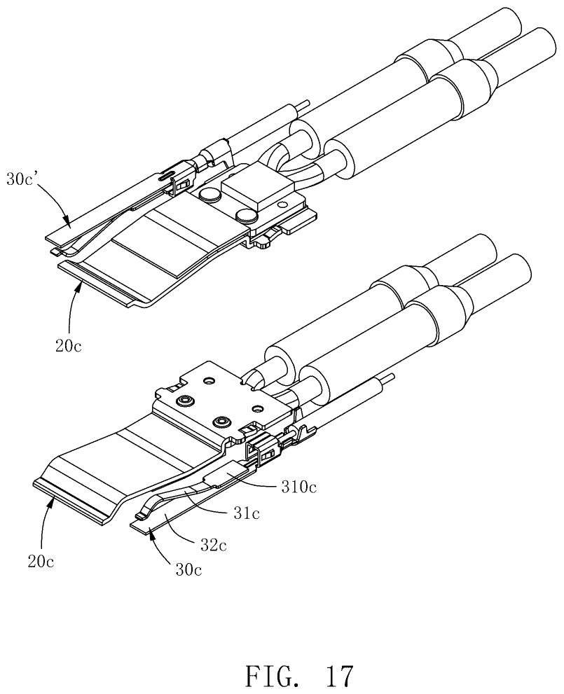

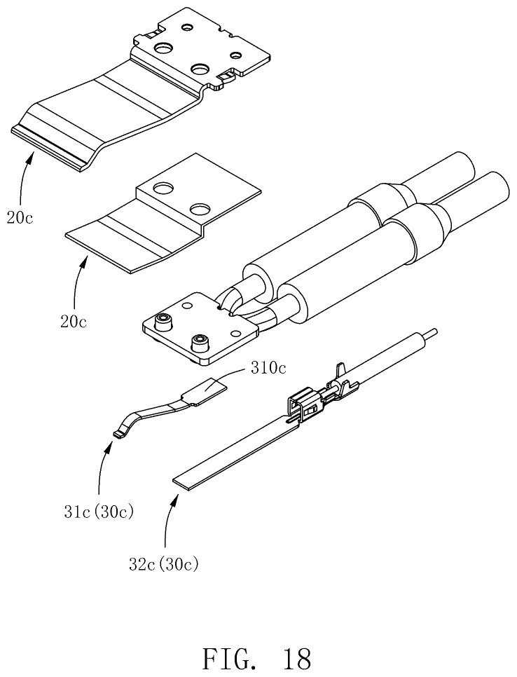

Please refer to FIGS. 16 to 18, which show a third embodiment of the present application, the third embodiment provides a power connector 1c. Like elements or structures of the third embodiment with the first embodiment of FIGS. 1 to 10 share the same reference numerals with the addition of the suffix “c”.

The structure of the power connector 1c of the third embodiment is roughly the same as that of the power connector 1 of the first embodiment. For example, in the third embodiment, the power connector 1c includes an insulation case 10c, a power transmission assembly 20c disposed in the insulation case 10c and located two vertical sides of a slot 11c, and at least one signal trigger mechanism 30c disposed in the insulation case 10c. The signal trigger mechanism 30c includes an active switch terminal 31c and a passive switch terminal 32c, which are independent of each other.

The other similar structures between the third embodiment and the first embodiment mentioned will not be elaborated here.

The main difference between the power connector 1c of the third embodiment and the power connector 1 of the first embodiment is that: in the third embodiment, the active switch terminal 31c is not connected to the power transmission assembly 20c; the active switch terminal 31c and the passive switch terminal 32c are both independent of the power transmission assembly 20c; and the active switch terminal 31c is directly fixed in the insulation case 10c through a switch fixing portion 310c. Specifically, the switch fixing portion 310c can be directly embedded in the insulation case 10c by an injection molding process, thereby fixing the active switch terminal 31c in one signal trigger mechanism-receiving groove 13c of the insulation case 10c. Of course, in other embodiments, the switch fixing portion 310c may be provided with a lock structure (not shown in drawings), which can fix the active switch terminal 31c in the signal trigger mechanism-receiving groove 13c.

The power connector 1c also includes another signal trigger mechanism 30c′. If the above signal trigger mechanism 30c is referred to as a first signal trigger mechanism, then the another signal trigger mechanism 30c′ is referred to as a second signal trigger mechanism. The first signal trigger mechanism and the second signal trigger mechanism can also adopt the structure shown in FIG. 11.

It is not difficult to know from the above three embodiments that the power connector of the present application can achieve the fixation of the active switch terminal by connecting the active switch terminal to the power transmission assembly (such as the first conductive plate or the first power terminal), or by disposing the active switch terminal in the insulation case independently without being connected to the active switch terminal to the power transmission assembly. Before the insert is inserted into the slot, the active switch terminal and the passive switch terminal are independent of each other and define the switch gap. But after the insert is inserted into the slot and the insert forces the active switch terminal to move, the active switch terminal can form electrical contact with the passive switch terminal.

As described above, the power connector of the present application, such as the power connector 1, disposes the active switch terminal 31 and the passive switch terminal 32, and then the passive switch terminal 32 is set on a movement path of the active switch terminal 31 pressed by the insert 7, so the active switch terminal 31 can touch the passive switch terminal 32 and establish electrical connection therebetween to trigger the power supply signal after the active switch terminal 31 is pressed down by the insert 7. Moreover, due to the independent arrangement of the active switch terminal 31 and the passive switch terminal 32, if the insert 7 is frequently inserted into the slot 11, the active switch terminal 31 will be frequently pressed, but the active switch terminal 31 will not affect the structural stability of the passive switch terminal 32. For example, the active switch terminal 31 will not cause the passive switch terminal 32 to loosen in the signal trigger mechanism-receiving groove 13, and will not cause the connection between the signal cable connection portion 321 and the signal cable 33 to loosen. When the active switch terminal 31 is pressed by the insert 7 and its active trigger end 312 moves toward the passive switch terminal 32, the passive switch terminal 32 can provide support to the active trigger end 312 to avoid excessive deformation of the active switch terminal 31. Hence, the power supply signal of the power connector 1 of the present application can be stably and accurately triggered and the power connector 1 has good safety.

It should be understood that, the application of the present application is not limited to the above examples listed. Ordinary technical personnel in this field can improve or change the applications according to the above descriptions, all of these improvements and transforms should belong to the scope of protection in the appended claims of the present application.

What is claimed is:

1. A power connector, comprising: an insulation case, a power transmission assembly being disposed in the insulation case, and at least one signal trigger mechanism being disposed in the insulation case; the insulation case having a slot for inserting an insert that can sequentially establish electrical contact with the power transmission assembly and the signal trigger mechanism;
the signal trigger mechanism comprising:
an active switch terminal having a switch fixing portion, an active contact portion, and an active trigger end arranged in sequence; the active contact portion protruding into the slot and being used to establish electrical contact with the insert; wherein, the active contact portion is brought into electrical contact with the insert only after the power transmission assembly is in electrical contact with the insert, and the active contact portion is forced by the insert to drive the active trigger end to move away from the slot; and
a passive switch terminal being independent of the active switch terminal and having a passive contact strip located on one vertical side of the active contact portion facing away from the slot; wherein, the passive contact strip is brought into electrical contact with the active trigger end after the active contact portion is pressed by the insert to cause movement of the active trigger end, and the passive contact strip breaks electrical contact with the active trigger end after the insert withdraws from the slot and releases the active contact portion.

2. The power connector according to claim 1, wherein,
the signal trigger mechanism and the power transmission assembly are arranged along a width direction of the slot; and
the active switch terminal and the passive switch terminal are arranged along a thickness direction of the slot and define a switch gap.

3. The power connector according to claim 1, wherein,
the switch fixing portion of the active switch terminal is connected to the power transmission assembly; and
the passive switch terminal is independent of the power transmission assembly.

4. The power connector according to claim 3, wherein,
the power transmission assembly includes a pair of power terminals and a pair of conductive plates;
the pair of power terminals are distributed on two vertical sides of the slot for making electrical contact with two opposite insertion surfaces of the insert;
the pair of conductive plates are respectively attached to outer surfaces of the pair of power terminals facing away from the slot;
the switch fixing portion is connected one conductive plate of the pair of conductive plates; and
the active trigger end is closer to the passive contact strip than the active contact portion.

5. The power connector according to claim 4, wherein,
the signal trigger mechanism is referred to as a first signal trigger mechanism;
the power connector comprises another signal trigger mechanism, which is referred to as a second signal trigger mechanism;
the second signal trigger mechanism has a same structure as the first signal trigger mechanism, and a different layout position from the first signal trigger mechanism;
wherein, the first signal trigger mechanism is arranged on one lateral side of the one conductive plate, and the active switch terminal is connected the one conductive plate; and the second signal trigger mechanism is arranged on one lateral side of the other conductive plate of the pair of conductive plates away from the first signal trigger mechanism, and an active switch terminal of the second signal trigger mechanism is connected the other conductive plate.

6. The power connector according to claim 5, wherein,
the insulation case disposes a pair of power transmission assembly-receiving grooves, which are respectively located on the two vertical sides of the slot for accommodating the power transmission assembly;
the insulation case disposes a pair of signal trigger mechanism-receiving grooves, which are respectively located on the two vertical sides of the slot for accommodating the first signal trigger mechanism and the second signal trigger mechanism; each of the signal trigger mechanism-receiving grooves is arranged side by side with the corresponding power transmission assembly-receiving groove along a width direction of the slot;
wherein, the power transmission assembly-receiving groove and the signal trigger mechanism-receiving groove located on one vertical side of the slot, and the power transmission assembly-receiving groove and the signal trigger mechanism-receiving groove located on the other vertical side of the slot, are arranged in parallel in a 180-degree horizontally flipped configuration;
wherein, in each of the signal trigger mechanism-receiving grooves, the active switch terminal is disposed adjacent to the slot, while the passive switch terminal is arranged on one vertical side of the active switch terminal opposite to the slot.

7. The power connector according to claim 6, wherein,
each of the signal trigger mechanism-receiving grooves is communicated with the corresponding power transmission assembly-receiving groove through a connection channel, and at least one part of the switch fixing portion of the active switch terminal passes through the connection channel.

8. The power connector according to claim 4, wherein,
each of the power terminals is bent vertically twice to form a Z-shape, and has a power contact portion protruding into the slot, a power body portion and a power cable connection portion arranged in sequence;
in the pair of power terminals, the power contact portions are used to commonly hold the insert, a gap between the power cable connection portions is less than a gap between the power body portions, and is less than or equal to a gap between the power contact portions.

9. The power connector according to claim 8, wherein,
each of the conductive plates is bent vertically twice to form a Z-shape, and has a reinforcing portion, a conductive body portion, and a conductive fixing portion arranged in sequence;
the conductive body portion is attached to the power body portion, the conductive fixing portion is attached to the power cable connection portion, and the reinforcing portion extends along the power contact portion; and
the switch fixing portion of the active switch terminal is connected to the conductive body portion of the conductive plate.

10. The power connector according to claim 9, wherein,
the active switch terminal and the conductive plate are configured as a one-piece structure or a two-piece structure;
the switch fixing portion of the active switch terminal is an L-shaped flat plate; one end of the switch fixing portion is connected to the conductive body portion, and the other end of the switch fixing portion is connected to the active contact portion;
the active contact portion is located on one lateral side of the power contact portion and behind the power contact portion.

11. The power connector according to claim 2, wherein,
the switch fixing portion, the active contact portion and the active trigger end of the active switch terminal are located on one vertical side of the passive switch terminal facing the slot; and
the passive contact strip of the passive switch terminal is flat, and a free end of the passive contact strip and the active trigger end are facing in a same direction.

12. The power connector according to claim 2, wherein,
the active contact portion and the active trigger end are located on one vertical side of the passive switch terminal facing the slot, and the switch fixing portion is located on the other vertical side of the passive switch terminal facing away from the slot;
the switch fixing portion is bent 180 degrees around a front end of the passive contact strip and connected to the active contact portion; the active trigger end is a free end of the active contact portion;
a free end of the passive contact strip and the active trigger end are facing in opposite directions.

13. The power connector according to claim 3, wherein,
the power transmission assembly at least includes a pair of power terminals, which are distributed on two vertical sides of the slot for making electrical contact with two opposite insertion surfaces of the insert;
the switch fixing portion of the active switch terminal is connected to one power terminal;
the active trigger end of the active switch terminal is closer to the passive contact strip of the passive switch terminal than the active contact portion.

14. The power connector according to claim 13, wherein,
each of the power terminals has a power contact portion protruding into the slot, a power body portion and a power cable connection portion arranged in sequence;
the switch fixing portion of the active switch terminal is connected to the power body portion of the corresponding power terminal.

15. The power connector according to claim 1, wherein,
the active switch terminal and the passive switch terminal are independent of the power transmission assembly;
the active switch terminal is directly fixed in the insulation case through the switch fixing portion;
the active switch terminal and the passive switch terminal are arranged along a thickness direction of the slot and define a switch gap.

16. A signal trigger mechanism, being used to establish electrical contact with an insert and trigger a signal, and comprising:
an active switch terminal having a switch fixing portion, an active contact portion and an active trigger end arranged in sequence; wherein, the active contact portion is used to establish electrical contact with the insert, and the active trigger end is forced to move after the active contact portion is in electrical contact with the insert; and
a passive switch terminal being independent of the active switch terminal; the active switch terminal and the passive switch terminal defining a switch gap; the passive switch terminal having a passive contact strip and a signal cable connection portion; the signal cable connection portion being connected to at least one signal cable, and the passive contact strip being located on a movement path of the active trigger end; wherein, the passive contact strip is brought into electrical contact with the active trigger end after the active contact portion is in electrical contact with the insert, and the passive contact strip breaks electrical contact with the active trigger end after the insert releases the active contact portion.

17. The signal trigger mechanism according to claim 16, wherein,
the switch gap is a distance between the active trigger end and the passive contact strip; and
the passive contact strip is flat, and a free end of the passive contact strip and the active trigger end are facing in a same direction or in opposite directions.
